(19) United States
(12) Patent Application Publication
(10) Pub. No.: US 2009/0321398 A1
(43) Pub. Date: Dec. 31, 2009

(54) METHOD AND DEVICE FOR MACHINING A TARGET USING A FEMTOSECOND LASER BEAM

(75) Inventors: Gerard Mourou, Paris (FR); Gilbert Boyer, Marseille (FR)

Correspondence Address: YOUNG & THOMPSON, 209 Madison Street, Suite 500, Alexandria, VA, 22314, US

(73) Assignees: ECOLE POLYTECHNIQUE, PALAISEAU CEDEX (FR); ECOLE NATIONALE SUPERIEURE DES TECHNIQUES AVANCEES, PARIS CEDEX 15 (FR); CENTRE NATIONAL DE LA RECHERCHE SCIENTIFIQUE, PARIS CEDEX 16 (FR)

(21) Appl. No.: 12/306,850

(22) PCT Filed: Jun. 28, 2007
(86) PCT No.: PCT/FR2007/001087

§ 371 Date: Aug. 11, 2009

(30) Foreign Application Priority Data
Jun. 29, 2006 (FR) 06/05838

(51) Int. Cl. B23K 26/06

(52) U.S. Cl. 219/121.69; 219/121.68

(57) ABSTRACT

The invention relates to a method and device for machining a target using a femtosecond laser beam. The invention consists in taking advantage of the deterministic nature of the ablation threshold and the nonlinear dependence thereof through the use of amplitude or phase pupillary filtering using the polarising effect or any other technique in order to reduce significantly the machining dimensions obtained by focusing a laser beam in nanotechnologies. One such filtering process modifies the distribution of the intensity in the focal plane such as to reduce the maximum of the central component of the spectrum of laser pulses while maintaining the bright rings below the deterministic ablation threshold. The invention associates the femtosecond ablation technique with deterministic threshold and the apodisation technique.

The present invention relates to a method and a device for machining a target by femtosecond laser beam. A particularly useful application relates to the field of nanotechnologies. However it can also be applied to other fields such as biotechnology or also the field of biochips.

The rapid growth of powerful lasers, which begun several decades ago, has paved the way to the discovery and study of numerous physical phenomena. In light-matter interactions alone, the outstanding progress in the field of the multi-ionization has to a certain extent overshadowed other phenomena such as optics at critical intensity (OCI). Nevertheless this system, which relates to the phase changes of a target under the effect of an intense, short radiation, is characterized by an extremely well-defined and reproducible transition threshold, making it the tool of choice for nanotechnologies which require ever-increasing precision and spatial resolution.

A recently-established property of OCI is that for laser pulses having a duration of less than 5 picoseconds, the damage threshold on the target becomes deterministic in a very reproducible way (better than 1%), in contrast to the random behaviour (20-50%), which characterizes ablations by laser pulses of greater duration for which this damage threshold varies according to the square root of the duration.

Previous studies which advanced the hypothesis according to which the OCI was apparently induced by a multiple ionization effect, which would appear to imply a significant reduction in the damage threshold with the duration of the laser pulses, have not proved possible to confirm by experimentation, which shows only a slight reduction in this threshold, followed by a plateau if the pulses become even shorter. On the basis of these observations another interpretation was successfully advanced, highlighting the predominant role of tunnel-effect ionization (Zener effect) combined with avalanche ionization, itself induced by the Zener effect.

Following this interpretation, supported by experiments involving laser pulses covering a wide range of durations (lasers of the “chirp-pulse amplification” or CPA laser type), the laser firstly creates a plasma. When the frequency of this plasma approaches that of that laser, the electric field undergoes a very strong amplification, having a cumulative effect on the generation of this plasma which comes to an end only when all the valence electrons of the target are ionized. When the frequency of the plasma exceeds that of the laser, it becomes absorbent, which causes ablation. Atomic force microscopy measurements show that the depth of the ablation is of the order of the thickness of the “skin effect” in accordance with this interpretation. This theory brings a solid basis to the deterministic nature of the ablation threshold. The process takes place even on dielectric materials, which become opaque when the electron density exceeds the critical damage threshold. This threshold is highly nonlinear in relation to intensity. Nonlinearity and determinism combine beneficially to allow the nanomachining of patterns below the limit imposed by diffraction (“thresholding”), the size of which is situated in the lower part of the nanometric scale, from 30 to 45 nm, with a very high reproducibility and a precision characterized by an unrivalled clarity of the ablation contours. In particular, document U.S. Pat. No. 5,656,186 is known in which a method is described which makes it possible to carry out reproducible ablations of a smaller size than the laser beam wavelength, the latter being pulsed and focused on or in the object to be processed.

Moreover, a technique is known for modifying the distribution of the focused light intensity using a spatial filtering in the rear focal plane of the lens which focuses the laser beam. This technique for remodelling the diffraction pattern in the focal plane, commonly called apodization (“point-spread engineering”) for historical reasons (although in this case, an increase in the diffraction “footprint” is sought) has features which can usefully be summarized as follows:—a reduction in the transverse and/or longitudinal dimension of the focused light spot by a variable proportion dependant on the apodizing filter; this is termed super resolution, i.e. focusing beyond the limit imposed by diffraction,

concomitant and regrettably inevitable increase in the secondary maxima, which will form a system of one or more bright rings concentric with the bright central spot; these rings vary in height according to the characteristics of the filter,

marked reduction in the overall efficiency, as a large part of the light intensity is thus “transferred” to the bright rings and as the apodizing filter itself causes absorption.

For a long time apodization has remained in the theoretical domain and has given rise to deep controversy as it appeared to contradict Heisenberg's uncertainty principle. Today apodization is regularly accepted as capable of increasing the spatial resolution of microscopes, but its application is extremely limited due to the height of the side lobes in the focusing pattern, making it unsuitable for nanomachining by laser beam, since these maxima can generate unwanted marks on the target.

The purpose of the present invention is to remedy the above-mentioned drawbacks by proposing a machining method having a high resolution. A further purpose of the invention is to carry out the machining of patterns of sizes much smaller than the wavelength of the laser beam. A further purpose of the invention is to carry out the machining of patterns of a smaller size, all other things being equal, than those obtained by the simple focusing of the laser beam.

At least one of the above-mentioned objectives is achieved with a method for machining a target by focusing a femtosecond laser beam using a focusing lens according to the technique known as deterministic-threshold femtosecond ablation, this method comprising the following steps:
an ablation threshold of the target is determined;
pupil spatial filtering of the laser beam reaching the lens is carried out in order to reduce the size of the central spot in the focal plane (according to the technique of apodization); said filtering being carried out so as to retain a part of the intensity of the central spot above said ablation threshold, and so as to maintain the side lobe intensity of the laser beam below said ablation threshold.

More specifically, as OCI ablation has a very well-defined threshold for a given material, it appears advantageous to combine it with apodization, since according to the above-mentioned characteristics, it allows smaller ablations and the increase in secondary maxima has no unwanted effect, providing that these maxima remain below the ablation threshold. The marked reduction in the focused intensity is easily compensated for by the use of chirped pulse amplification lasers, or CPA. In other words, the present invention can be considered as an intelligent combination of two techniques:

apodization, a concept which consists of modifying the diffraction pattern around the focus of a lens, under certain constraints, by the design of amplitude and/or phase filters; and

deterministic threshold femtosecond ablation, a concept by which the ablation takes place only above a certain very well-defined power threshold which is reproducible for the parameters of the experiment: the light energy outside the focal point has no effect, neither for ablation nor damage. This peripheral energy is all the more significant as the narrowing of the central spot due to apodization increases.

The OCI ablation laser according to the present invention finally makes it possible to resolve the problem of unwanted marks due to the presence of the side lobes in the focusing pattern during implementation of the apodization. Indeed, by the simple fact of remaining below the ablation threshold, these lobes have no effect.

Most frequently the target is made of dielectric material. But it can also be made of metal material.

By way of example, said ablation threshold can be determined by firstly focusing the laser beam on a test target, then by adjusting the power of the beam so that only the central maximum of the focused diffraction pattern generates an ablation.

By femtosecond laser is meant a laser transmitting laser pulses of a duration substantially less than 5 picoseconds.

With the method according to the present invention, by keeping the height of the side lobes below the ablation threshold, and by reducing the width of the intensity profile of the laser beam, the ablation takes place with a focal point of a smaller size than the limit imposed by diffraction which, combined with the threshold effect and the non-linear character of the ablation, makes it possible to cut patterns of an even smaller size for nanotechnologies.

With the method according to the invention, it is possible to cut patterns, the dimensions of which are comprised between 19 and 29 nm.

According to an advantageous feature of the invention, said pupil filtering comprises a phase filtering, an amplitude filtering or a combination of phase and amplitude filtering. In other words, altering the phase, the amplitude, or a combination of the two.

By way of example, pupil spatial filtering can be carried out using a photographic plate or a photographic film.

Advantageously, pupil spatial filtering can be carried out using a liquid-crystal modulator or adaptive optics mirror. In fact the use of adaptive optics mirrors and liquid crystal matrices makes it possible to produce high-precision filters.

According to an advantageous embodiment of the invention, the topography of the filter is of a binary type comprising in particular dark, light or grey rings.

Alternatively, the topography of the filter can be of a continuous variation type.

According to an embodiment of the present invention, the filtering is carried out by placing a filter upstream of the focusing lens. This filtering can also be carried out by introducing a filter into a relay optical system forming an image of said filter on the rear focal plane of the focusing lens.

According to another aspect of the invention, a device is proposed for machining a target by focusing a femtosecond laser beam using a focusing lens according to the deterministic threshold femtosecond ablation technique. According to the invention, this device comprises means of pupil spatial filtering, arranged upstream of said focusing lens, in order to reduce the size of the central spot of the laser beam in the focal plane; these filtering means being dimensioned so as to retain a part of the intensity of the central spot above a determined ablation threshold, and so as to keep the intensity of the side lobes of the laser beam below said ablation threshold.

Other advantages and characteristics of the invention will become apparent on examination of the detailed description of an embodiment which is in no way limitative, and the attached drawings, in which:

FIG. 1 is an image of an example of retinal detachment according to the prior art;

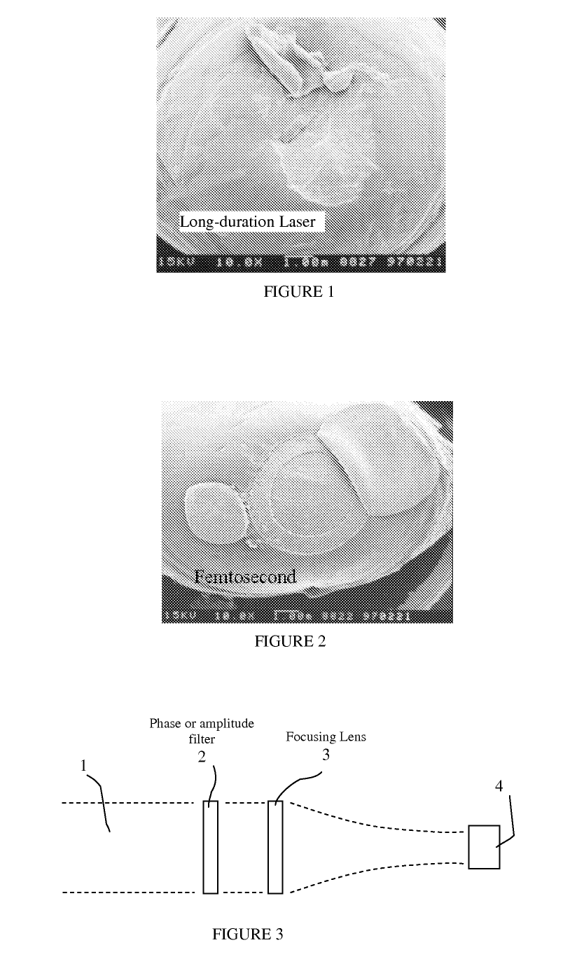

FIG. 2 is an image of a further example of retinal detachment by pulsed laser according to the prior art;

FIG. 3 is a simplified diagrammatic view of an embodiment according to the present invention;

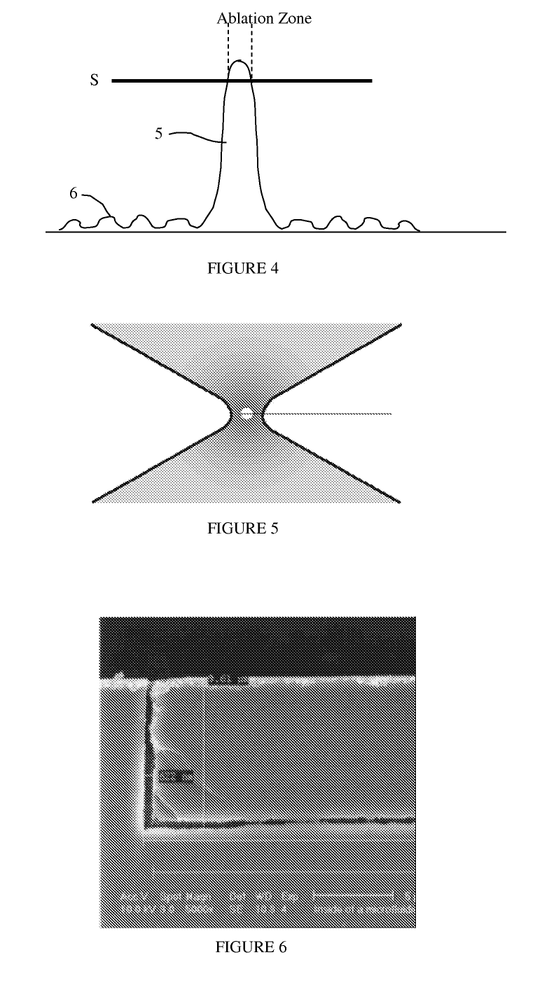

FIG. 4 is a graph showing the intensity curve of the pulsed laser beam reaching the target according to the present invention;

FIG. 5 is a diagrammatic view of the focused laser beam according to the present invention;

FIG. 6 is a view of an in-depth nano-machining using a method according to the present invention.

FIG. 1 shows a poor-quality ablation carried out using a picosecond laser according to the prior art. This ablation requires subsequent manual intervention to finalize the incision. Still in the prior art, as described in particular in the document U.S. Pat. No. 5,656,186, it is known to perform ablations by femtosecond laser. FIG. 2 shows an operation of this type in which two lamellar concentric incisions have been performed, accurately delimited by a precise, clean contour. The ablation zone with such a method is approximately one millimetre. In the prior art, the ablation is carried out by a short-pulse laser beam (less than 100 fs) focused by a microscope lens. The entrance pupil of this lens is called “clear” as it does not include any obstruction or modification of the wave-front phase of the incident beam. The distribution of the focused intensity is then that of the “Airy disk” which concentrates 48% of the focused energy in a circle containing the intensities greater than or equal to one half of the maximum intensity and 84% in a circle surrounded by a dark ring due to diffraction; the remainder being contained in bright concentric rings.

FIG. 3 is a diagram illustrating an embodiment of the present invention. A pulsed femtosecond laser beam 1 can be seen, directed towards a phase filter 2, which can be either an amplitude filter or a combination of phase and amplitude filter. The beam output from the filter 2 passes through a lens 3, the function of which is to focus the laser beam on or in a target 4 of dielectric material. FIG. 4 shows an intensity curve of the laser beam reaching the target. The action of the filter 2 on the laser beam constitutes an apodization step, making it possible to narrow the transverse dimension of the central maximum 5, i.e. the distribution of the light intensity at the centre is narrower than that which would be obtained without such a filter. In order to compensate for the reduction in luminosity at this centre, a powerful and stable femtosecond laser is used. FIG. 5 is a simplified diagram showing a representation of the focusing plane of the pulsed laser beam. With such an arrangement, high-resolution deep nano-machining as shown in FIG. 6 can be performed. The cuts are accurate, virtually linear, and have a diameter of approximately 622 nm at a depth of 9.61 μm.

The following is an example of determination of the ablation threshold and adjustment of the power of the laser:

the ablation threshold is measured on a test target placed in the focal plane of the lens comprising the apodizing filter (or its optical image) in its rear focal plane, and

the power of the femtosecond laser pulses is adjusted so that ablation takes place only at the bright spot.

By way of example, the characteristics of a device according to the present invention can be as follows: a phase filter comprising three annular zones and introducing a frame shift corresponding to a half-wavelength of the central component of the spectrum of the laser pulses. This phase filter narrows the maximum of the central component, the diameter of which then becomes equal to 0.58 times its non-filtered homologue, while the bright rings are all less than or equal to a fraction of the maximum intensity. In this example, this fraction is approximately equal to 0.8. As the ablation threshold is very accurately determined, nano-machining takes place only around the central maximum of intensity, with a reduction in the diameter of the ablation of almost 73% without the bright rings having any effect on this ablation. As a result of the reduction of the transverse dimension of the nano-engraving, the increase in the surface area of the writing density—and thus the information—is multiplied in this way by almost a factor of three.

The phase filter used is such that the diameters (in relation to the diameter of the lens pupil) of the inner dephasing ring are: 0.125, 0.215; those of the intermediate ring are: 0.379, 0.531; and those of the outer ring are: 0.746 and 1.0.

The present invention can therefore be applied in the nanotechnologies, for example for the design of optical sensors or for telecommunications generally. It can be applied in particular to the generation of nanocrystallites by femtosecond laser ablation. These nanoparticles have exceptional non-linear properties of interest to the nanotechnologies and biosciences.

The invention also relates to the field of apodization, in which an increasing number of microscopy studies are noted, particularly in multiphotonic microscopy, where specifically the significance of the increase in secondary maxima is drastically reduced by the non-linear effects of two- and three-photon absorption fluorescence, and by generation of second and third harmonics.

Of course, the invention is not limited to the examples which have just been described, and numerous adjustments can be made to these examples without exceeding the scope of the invention.

1. Method for machining a target by focusing a femtosecond laser beam using a focusing lens according to the technique known as deterministic threshold femtosecond ablation, this method comprising the following steps:
an ablation threshold of the target is determined;
pupil spatial filtering of the laser beam reaching the lens is carried out in order to reduce the size of the central spot in the focal plane according to the technique of apodization; said filtering being carried out so as to retain a part of the intensity of the central spot above said ablation threshold, and so as to maintain the side lobe intensity of the laser beam below said ablation threshold.

2. Method according to claim 1, characterized in that said pupil filtering comprises a phase filtering.

3. Method according to claim 1, characterized in that said pupil filtering comprises an amplitude filtering.

4. Method according to claim 1, characterized in that said ablation threshold is determined by firstly focusing the laser beam on a test target, then by adjusting the power of the beam so that only the central maximum of the focused diffraction pattern generates an ablation.

5. Method according to claim 1, characterized in that said pupil filtering comprises a combination of phase and amplitude filtering.

6. Method according to claim 1, characterized in that the pupil spatial filtering is carried out using a photographic plate.

7. Method according to claim 1, characterized in that the pupil spatial filtering is carried out using a photographic film.

8. Method according to claim 1, characterized in that the pupil spatial filtering is carried out using a liquid crystal modulator.

9. Method according to claim 1, characterized in that the pupil spatial filtering is carried out using an adaptive-optics mirror.

10. Method according to claim 1, characterized in that the topography of the filter is of binary type.

11. Method according to claim 1, characterized in that the topography of the filter is of continuous-variation type.

12. Method according to claim 1, characterized in that the filtering is carried out by placing a filter upstream of said focusing lens.

13. Method according to claim 1, characterized in that the filtering is carried out by introducing a filter into a relay optical system forming an image of said filter on the rear focal plane of the focusing lens.

14. Method according to claim 1, characterized in that the laser beam is generated from a chirped-pulse amplification laser.

15. Method according to claim 1, characterized in that the target is made of dielectric or metal material.

16. Device for machining a target by focusing a femtosecond laser beam using a focusing lens according to the technique called deterministic threshold femtosecond ablation, this device comprising
means of pupil spatial filtering, arranged upstream of said focusing lens, in order to reduce the size of the central spot of the laser beam in the focal plane; these filtering means being dimensioned so as to retain a part of the intensity of the central spot above a determined ablation threshold, and so as to keep the intensity of the side lobes of the laser beam below said ablation threshold.

17. Device according to claim 16, characterized in that the filtering means comprise a phase filter.

18. Device according to claim 16, characterized in that the filtering means comprise an amplitude filter.

19. Device according to claim 16, characterized in that the filtering means comprise a combination of phase and amplitude filters.
